(19) United States
(12) Patent Application Publication
(10) Pub. No.: US 2011/0054788 A1
(43) Pub. Date: Mar. 3, 2011

(54) Personal calendar Updates and hand held communication devices

(76) Inventor: Vic Iyer, Fremont, CA (US)

(21) Appl. No.: 12/551,562

(22) Filed: Sep. 1, 2009

(51) Int. Cl. H04M 3/42; G10L 15/00; G01C 21/00

(52) U.S. Cl. 701/213; 455/414.1; 704/270; 704/E15.001

(57) ABSTRACT

Methods and systems are provided for updating calendar and appointments based on a conversation on the hand held device. The software application and/or device shall sense the end of the call and prompt the user to decide if the call resulted in an appointment. If he answers in the affirmative, he is taken to the calendar application within the device to update his calendar with the appointment.

### BACKGROUND

With the ever increasing pace of life and reliance on hand held devices to organize our lives, users of hand held devices, especially phones, find themselves finishing a phone call with an action item. More often than not, this action item is an appointment to keep.

Presently, users have to remember to update the calendar when they get back to the office or home or some other such place.

This invention seeks to make this easy and prevent omissions by providing a method and process to enable the user to enter the appointment into the calendar at the end of the call.

An additional feature of this invention would be to enable the user to do this by answering prompts on the handheld device using the hand held device physical or on screen keyboard.

An additional feature of this invention would be to enable the user to do this using the interactive voice response system that would be built into the system.

### CROSS-REFERENCE TO RELATED APPLICATIONS

None

### TECHNICAL FIELD

This invention relates to methods and systems for updating a calendar or task list based on the conversation with a party.

### SUMMARY

This application seeks to solve this problem for users by providing the methods and process to address this need of the users.

What is claimed is:

1. A method for updating the appointment calendar on the calendar application upon termination of a call with a calling party on the hand held device.

2. The method of claim 1, further comprising the ability to update the appointments on the calendar application upon termination of a call with a called party on the hand held device.

3. The method of claim 2, further allowing the user to use the physical or on screen keyboard on the device to execute the update.

4. The method of claim 3, further allowing the user to use the interactive voice response system built in to the device or the application to execute the update.

5. The method of claim 4, whereby hand held device senses the users location through GPS and calculates the time to the nearest appointment, again using GPS, to remind him of the need to leave or call the person with whom the appointment is set to inform, reschedule or otherwise confirm the appointment.

5. The method of claim 5, whereby data can be updated to the calendar application in the hand held device and then passed on to the user's outlook or other calendar or vice versa.

6. The method of claim 6, whereby the phone number is included in the appointment data for follow up from the calendar itself to confirm, reschedule or otherwise deal with the appointment.
